(19) United States
(12) Patent Application Publication
(10) Pub. No.: US 2007/0206558 A1
(43) Pub. Date: Sep. 6, 2007

(54) METHOD AND APPARATUS FOR TRANSMITTING DISTRIBUTED FDMA AND LOCALIZED FDMA WITHIN A SAME FREQUENCY BAND

(75) Inventors: Hidenori Akita, Tokyo (JP); Masaya Fukuta, MEGURO-KU, 13 (JP); Hiroshi Hayashi, TOKYO-TO (JP)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/276,462

(22) Filed: Mar. 1, 2006

(51) Int. Cl. H04B 7/208

(52) U.S. Cl. 370/344; 370/401

(57) ABSTRACT

A method and apparatus for using both D-FDMA and L-FDMA within a same frequency band is provided herein. The proposed technique scatters the sub-carriers of each D-FDMA user to a frequency band utilized by L-FDMA communications without separating the total band into exclusive D-FDMA and L-FDMA sub-bands. The L-FDMA users are assigned to the gap of the D-FDMA sub-carriers. Therefore, frequency diversity gain of D-FDMA by the proposed method is larger than if D-FDMA and L-FDMA sub-bands were created.

### FIELD OF THE INVENTION

The present invention relates generally to communication systems utilizing a Frequency Division Multiple Access (FDMA) communication scheme and in particular, to a method and apparatus for using distributed-FDMA and localized-FDMA within a communication system.

### BACKGROUND OF THE INVENTION

The 3rd Generation Partnership Project (3GPP) is discussing a long-term evolution (LTE) of the 3GPP radio access technology. Single carrier (SC) frequency division multiple access (FDMA) is a candidate for the uplink multiple access of the 3GPP LTE mainly because the Peak-to-Average Power Ratio (PAPR) of a multiple access based on single carrier is smaller than that based on multi-carrier such as OFDM. The proposed SC-FDMA in the 3GPP LTE is divided into two multiple access schemes. One is distributed-FDMA (D-FDMA); the other is localized-FDMA (L-FDMA). Since these two schemes have different advantages in terms of frequency diversity, the coexistence of D-FDMA and L-FDMA within a same frequency band improves the throughput performance. Therefore, a need exists for a method and apparatus for using both D-FDMA and L-FDMA within a same frequency band.

### BRIEF DESCRIPTION OF THE DRAWINGS

FIG. 1 is a block diagram of a communication system.

FIG. 2 is a block diagram of a D-FDMA transmitter.

FIG. 3 illustrates operation of a block repeater.

FIG. 4 illustrates D-FDMA transmission.

FIG. 5 is a block diagram of an L-FDMA transmitter.

FIG. 6 illustrates L-FDMA transmission.

FIG. 7 illustrates D-FDMA and L-FDMA transmission within a same frequency band.

FIG. 8 is a flow chart showing operation of the base station of FIG. 1.

FIG. 9 is a flow chart showing operation of the transmitter of FIG. 2.

FIG. 10 is a block diagram of a D-FDMA modulator.

### DETAILED DESCRIPTION OF THE DRAWINGS

In order to address the above-mentioned need, a method and apparatus for using both D-FDMA and L-FDMA within a same frequency band is provided herein. The proposed technique scatters the sub-carriers of each D-FDMA user to a frequency band utilized by L-FDMA communications without separating the total band into exclusive D-FDMA and L-FDMA sub-bands. The L-FDMA users are assigned to the gap of the D-FDMA sub-carriers. Therefore, frequency diversity gain of D-FDMA by the proposed method is larger than if D-FDMA and L-FDMA sub-bands were created.

The present invention additionally encompasses a method comprising the steps of encoding information bits into symbols, mapping the symbols into an mQAM constellation to produce modulated symbols, and packing the modulated symbols into a block. The block of symbols is repeated a number of times and multiplied by a user-dependent frequency shift vector to produce a transmission stream. Finally, the transmission stream is transmitted using a D-FDMA transmission scheme wherein D-FDMA transmissions take place within gaps of L-FDMA transmissions.

The present invention additionally encompasses an apparatus comprising a receiver receiving D-FDMA parameters and a transmitter transmitting using a D-FDMA transmission scheme, wherein D-FDMA transmissions take place within gaps of L-FDMA transmissions from other users.

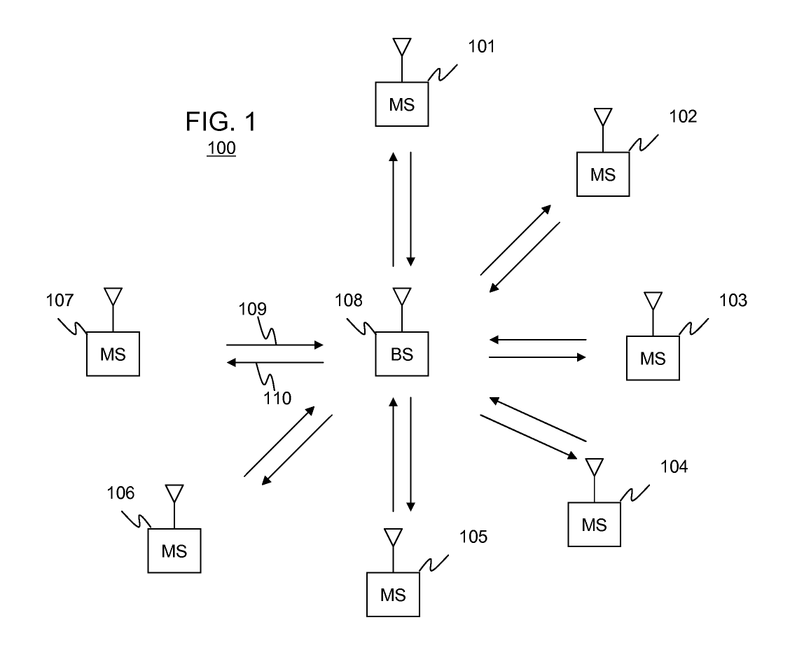

Turning now to the drawings, wherein like numerals designate like components, FIG. 1 is a block diagram of communication system 100. As shown, communication system 100 comprises a plurality of mobile stations 101-107 in communication with base station 108. During communication, transmissions from mobile stations 101-107 to base station 108 take place utilizing uplink communication signals 109 (only one uplink signal 109 is labeled), while communication from base station 108 to any mobile station 101-107 takes place utilizing downlink communication signal 110 (only one downlink communication signal 110 is labeled).

When multiple mobile stations 101-107 are simultaneously uploading information data via uplink signals 109, base station 108 allocates a part of the entire frequency band to each mobile station 101-107. Base station 108 signals the frequency allocation to each mobile station 101-107 by specifying the number of sub-carriers and the frequency offset through downlink communication signals 110. Moreover, base station 108 decides spacing of the active sub-carriers for each mobile station 101-107 based on a type of the information data and the propagation channel condition. The sub-carrier spacing is also signaled to mobile stations 101-107 through the downlink signals 110. Mobile stations 101-107 then transmit information (data) using the specified sub-carrier spacing, number of sub-carriers and frequency offset.

During operation mobile stations 101-107 can transmit utilizing D-FDMA or L-FDMA. For example only, it is assumed that mobile stations 101, 103, and 105 utilize a D-FDMA uplink transmission scheme, while mobile stations 102, 104, 106, and 107 utilize an L-FDMA uplink transmission scheme.

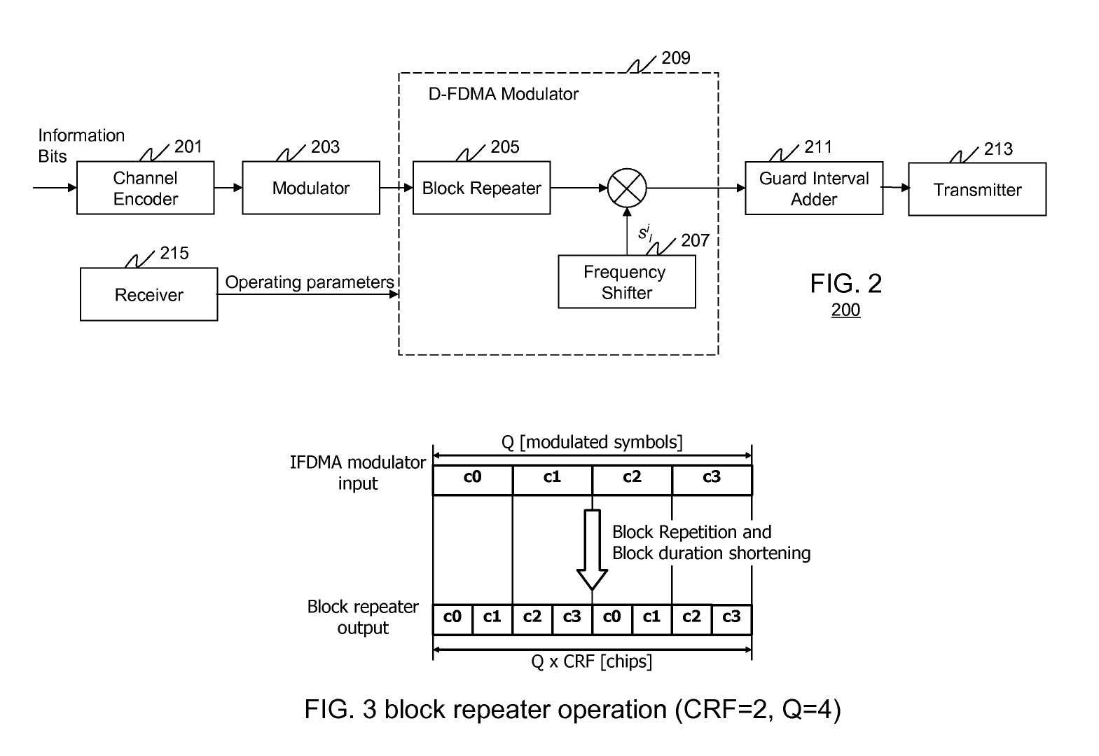

FIG. 2 shows distributed-FDMA transmitter 200. As shown, D-FDMA transmitter 200 comprises channel encoder 201, modulator 203, block repeater 205, frequency shifter 207, and optional guard interval adder 211. During operation data (information bits) enters channel encoder 201 which encodes the information bits to form symbols via a known encoding technique. Symbols are output to modulator 203 which maps the encoded bits (symbols) to an mQAM constellation. The Q modulated symbols are packed into a block by modulator 203 and sent to D-FDMA modulator 209. Block repeater 205 in D-FDMA modulator 209 repeats the input block a number of times equal to a CRF (Chip Repetition Factor), and shortens block duration by 1/CRF. It should be noted that Q and CRF are equal to the specified number of sub-carriers and the specified sub-carrier spacing respectively. For the D-FDMA transmission, it is assumed that the product of Q and CRF is constant, equal to the total number of sub-carriers. An example of block repeater operation is illustrated in FIG. 3.

As shown in FIG. 3, the repeated symbols (chips) are multiplied by user dependent frequency shift vector sⁱₗ. where,
sₗⁱ=e^{-j·l·Φ(F}^{_{offs}}⁾ (l=0,1, . . . ,Q×CRF−1, 0≦F_{offs}≦CRF−1)
where,

l: chip index

F_{offs}: user dependent frequency offset in number of sub-carriers

Φ(F_{offs}): user dependent frequency offset in radian given by

$$Φ ( {F}_{offs} ) = {F}_{offs} \cdot \frac{2 π}{Q \cdot CRF} .$$

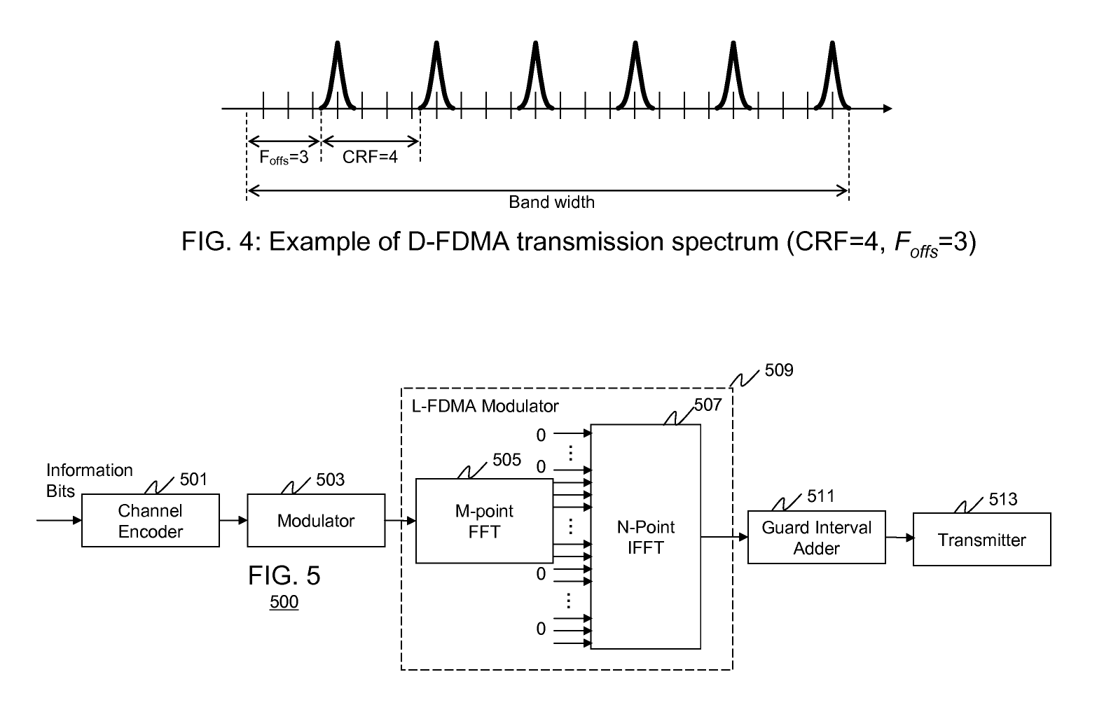

The block-repeated symbols are multiplied by the user-dependent frequency shift vector. Finally, the last v chips are copied to the beginning of D-FDMA modulator output by the guard interval adder 211 and transmitted via transmitter 213. An example of D-FDMA transmission spectrum is illustrated in FIG. 4. The duration of the sub-carriers is regular interval. This interval length is CRF. The user dependent frequency offset F_{offs} adjusts the position of the sub-carriers set in order to maintain orthogonality between the different users.

D-FDMA obtains frequency diversity gain without using a frequency scheduling technique because the sub-carriers of each user are scattered in the band. Therefore, D-FDMA is suitable for delay critical channels because frequency scheduling technique isn't applied to these channels.

FIG. 5 is a block diagram of localized-FDMA (L-FDMA) transmitter 500. As shown, transmitter 500 comprises channel encoder 501, modulator 503 M-point Fast Fourier Transformer (FFT) 505, N-point Inverse Fast Fourier Transformer (IFFT) 507, and an optional guard interval adder 511. During operation channel encoder 501 encodes the information bits to produce information symbols. Modulator maps the encoded bits to a mQAM-constellation. The M modulated symbols (where block size M is equal to the specified number of sub-carriers allocated by base station 108) are packed into a block by modulator 503 and sent to L-FDMA modulator 509. The input block of L-FDMA modulator is transferred to frequency domain by M-point FFT 505 and mapped to the localized band within the total band. The elements within the total band are 0 except for the assigned localized band. All elements within the total band are transferred to the time domain by N-point IFFT 507. Finally, the last v chips are copied to the beginning of L-FDMA modulator output by guard interval adder 511 and transmitted via transmitter 513.

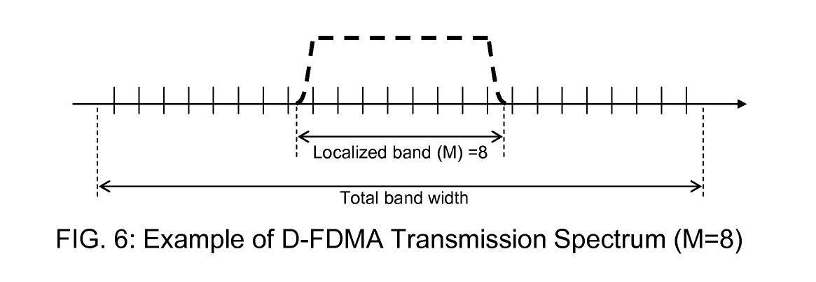

An example of L-FDMA transmission spectrum is illustrated in FIG. 6. The localized band width is the input block size of L-FDMA modulator 509. Each user is assigned to the orthogonal localized band for maintaining orthogonality between the different users. L-FDMA is suitable for traffic data channels because L-FDMA can assign these channels to high SNIR localized band by frequency scheduling technique.

As discussed above, D-FDMA is suitable for delay critical channels because D-FDMA obtains frequency diversity gain without using a frequency scheduling technique while L-FDMA is suitable for traffic data channels because L-FDMA can assign these channels to high SNIR localized band by using a frequency scheduling technique. Therefore, using D-FDMA and L-FDMA appropriately depending on the channel types improves the throughput performance. In order to accomplish this, a method and apparatus for using both D-FDMA and L-FDMA within a same frequency band is utilized. The proposed technique scatters the sub-carriers of each D-FDMA user to a frequency band utilized by L-FDMA communications without separating the total band into a D-FDMA sub-band and an L-FDMA sub-band. The L-FDMA users are assigned to the gaps of the D-FDMA sub-carriers. Therefore, frequency diversity gain of D-FDMA by the proposed method is larger than if D-FDMA and L-FDMA sub-bands were created.

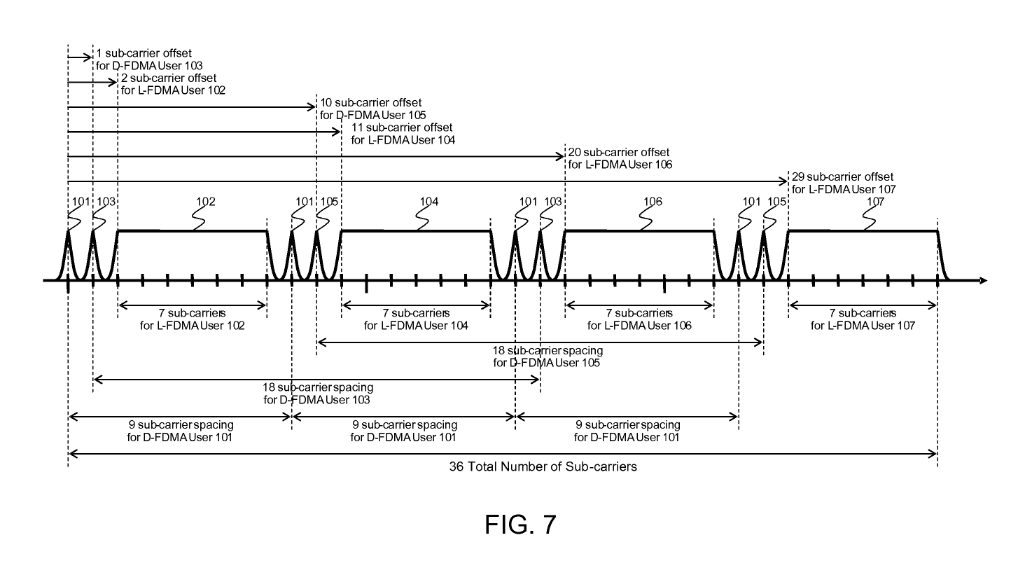

FIG. 7 shows an example of the proposed method for using both D-FDMA and L-FDMA within a same frequency band. The chip repetition factor (CRF) and the user dependent frequency offset (F_{offs}) of each D-FDMA user assure the required gap length of each D-FDMA user. More specifically, CRF and F_{offs} are chosen by transmitter 200 so that all transmissions take place within gaps of the L-FDMA transmission scheme. In one embodiment of the present invention, each mobile station 101-107 requests particular values of operational parameters from base station 108 with base station 108 finally deciding the parameters by analyzing the requests. Alternatively, each mobile station 101-107 may simply request transmission using either D-FDMA or L-FDMA, with base station 108 determining the appropriate operating parameters.

The sub-carrier spacing for D-FDMA users is maximized to obtain the frequency diversity. As an example, consider seven users (transmitters), four users transmitting L-FDMA transmissions and three users transmitting D-FDMA transmissions. Each user will transmit within a single frequency band. Tables 1 and 2 show the parameters of each user of this example.

TABLE 1
D-FDMA user parameters

| | Sub- | | |
|---|---|---|---|
| | carrier spacing | Number of sub- | Frequency offset |
| | (CRF) | carriers (Q) | (F_{offs}) |
| D-FDMA User 101 | 9 | 4 | 0 |
| D-FDMA User 103 | 18 | 2 | 1 |
| D-FDMA User 105 | 18 | 2 | 10 |

TABLE 2
L-FDMA user parameters

| | Sub-carrier | Number of sub- | Frequency offset |
|---|---|---|---|
| | spacing | carriers (M) | (F_{offs}) |
| L-FDMA User 102 | 1 | 7 | 2 |
| L-FDMA User 104 | 1 | 7 | 11 |
| L-FDMA User 106 | 1 | 7 | 20 |
| L-FDMA User 107 | 1 | 7 | 29 |

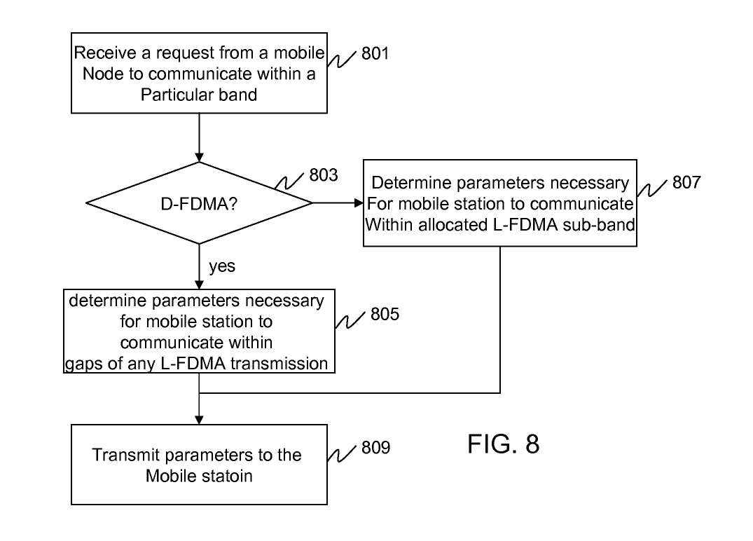

FIG. 8 is a flow chart showing operation of base station 108. Particularly, FIG. 8 shows the steps necessary for base station 108 to assure D-FDMA transmissions within the frequency gaps of L-FDMA transmissions. The logic flow begins at step 801 where base station 801 receives a request from a mobile node 101-107 to communicate within a particular band (e.g., utilizing some of the 36 sub-carriers of FIG. 7). Base station 108 determines if the transmission will be L-FDMA or D-FDMA (step 803) and if the transmissions will be D-FDMA, the logic flow continues to step 805, otherwise the logic flow continues to step 807. At step 805, base station 108 determines the parameters necessary for the mobile station to communicate within the gaps of any L-FDMA transmission and the logic flow continues to step 809. At step 807 base station 108 determines the parameters necessary for the mobile station to transmit using one of the allocated L-FDMA sub-bands and the logic flow continues to step 809 where the operating parameters are transmitted to the mobile station.

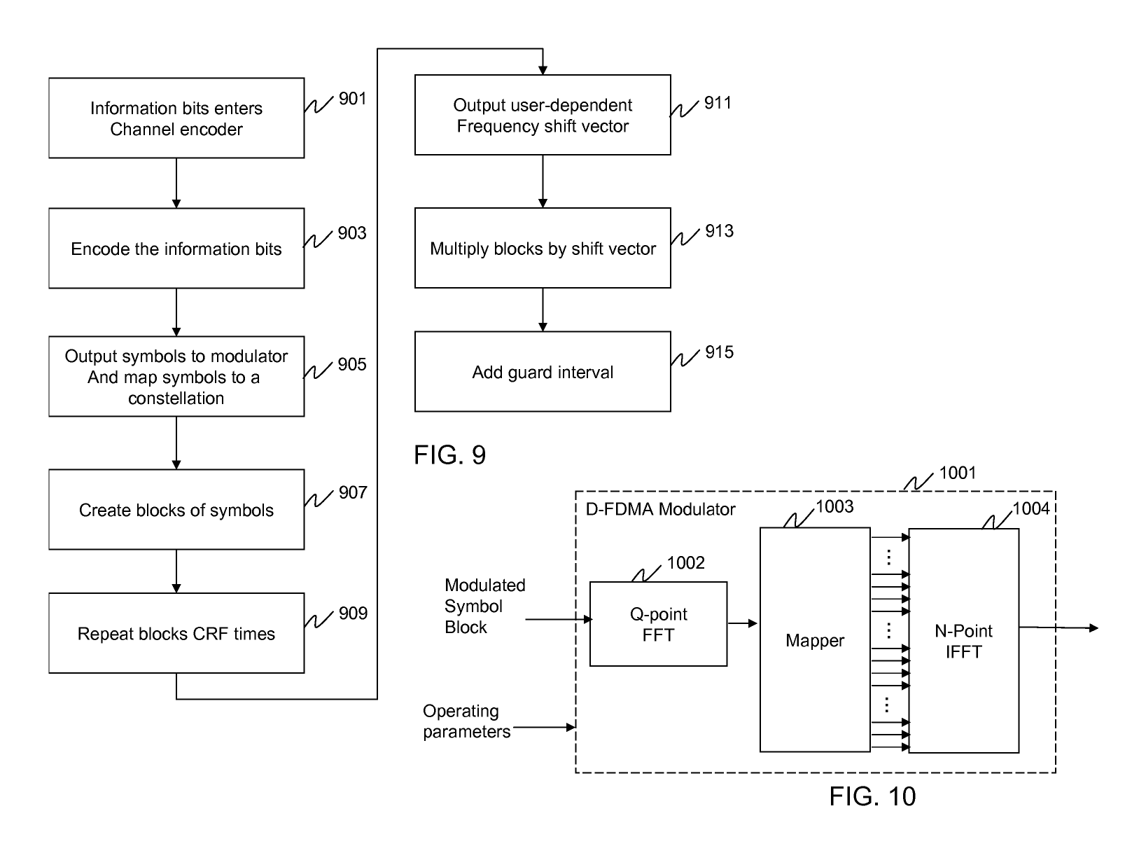

FIG. 9 is a flow chart showing operation of D-FDMA transmitter 200. The logic flow below assumes that at least one operating parameter such as CRF, Q, and F_{offs} have been received from base station 108. This is accomplished by receiver 215 receiving over-the-air communications from base station 108 containing the operating parameters. These parameter(s) may be requested from base station 108 via transmitter 213 transmitting a request to communicate.

The logic flow begins at step 901 where data (information bits) enters channel encoder 201. Channel encoder 201 uses standard encoding techniques to encode the information bits to form symbols (step 903). At step 905 symbols are output to modulator 203 which maps the encoded bits (symbols) to an mQAM-constellation. At step 907 the Q modulated symbols are packed into a block by modulator 203 and sent to D-FDMA modulator 209. At step 909, block repeater 205 repeats the input block a number of times equal to a CRF (Chip Repetition Factor), and shortens block duration by 1/CRF. At step 911, frequency shifter outputs a user-dependent frequency shift vector sⁱₗ, based on F_{offs}. The CRF is the interval of sub-carriers of the D-FDMA user, while F_{offs} gives the position of sub-carriers of the D-FDMA user (see FIG. 3). The CRF and the Foffs assure the gap length, which is greater than the localized band width of each L-FDMA user. The each gap of the D-FDMA sub-carriers should be greater than the localized band width of each L-FDMA user.

Continuing, the repeated symbols output from block repeater 205 are multiplied by the user-dependent frequency shift vector sⁱₗ to produce a transmission stream. The transmission stream is optionally output guard interval adder 211 (step 913) where at step 915 a guard interval is added. Regardless of whether or not a guard interval is added, the transmission stream is transmitted via transmitter 213. As discussed above, the values chosen for CRF and F_{offs} result in the D-FDMA transmission scheme taking place within gaps of the L-FDMA transmissions.

FIG. 10 shows modulator 1001 which can replace modulator 209 in D-FDMA transmitter 200. As shown, D-FDMA modulator 1001 comprises Q-point Fast Fourier Transformer (FFT) 1002, mapper 1003 and N-point Inverse Fast Fourier Transformer (IFFT) 1004. During operation the Q modulated symbols (where block size Q is equal to the specified number of sub-carriers allocated by base station 108) are packed into a block by modulator 203 and sent to D-FDMA modulator 1001. The input block of D-FDMA modulator 1001 is transferred to frequency domain by Q-point FFT 1002. Q-point FFT 1002 outputs a fast Fourier Transform of the modulated symbol block and passes a frequency domain signal to mapper 1003. Mapper 1003 maps the elements of the transferred block to the appropriate frequencies in the distributed band within the total band and outputs Q information streams to N-Point IFFT 1004. The elements within the total band are 0 except for the assigned distributed band. The position and spacing of the distributed band is assured by CRF and F_{offs} as shown in FIG. 4. All elements within the total band are transferred to time domain by N-point IFFT 1004 where they are converted to the time domain and sent to guard interval adder 211. As discussed above, the D-FDMA transmissions take place within gaps of L-FDMA transmissions from other users.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for transmitting distributed frequency division multiple access (D-FDMA) within a same frequency band as localized-FDMA (L-FDMA) transmissions, the method comprising the steps of:
transmitting using a D-FDMA transmission scheme, wherein D-FDMA transmissions take place within gaps of L-FDMA transmissions from other users.

2. The method of claim 1 further comprising the step of:
receiving D-FDMA parameters from a base station.

3. The method of claim 1 wherein the step of receiving the D-FDMA parameters comprises the step of receiving values for CRF, Q, and F_{offs}, where CRF comprises a chip repetition factor, Q comprises a number of subcarriers, and F_{offs} comprises a user dependent frequency offset.

4. The method of claim 1 further comprising the step of:
requesting from a base station, the D-FDMA parameters.

5. The method of claim 1 further comprising the steps of:
requesting from a base station, the D-FDMA parameters; and
receiving values for at least one of CRF, Q, and F_{offs} in response to the request.

6. A method comprising the steps of:
encoding information bits into symbols;
mapping the symbols into an mQAM constellation to produce modulated symbols;
packing the modulated symbols into a block;
repeating the block of symbols a number of times;
multiplying the block repeated symbols by a user-dependent frequency shift vector to produce a transmission stream; and
transmitting the transmission stream using a D-FDMA transmission scheme wherein D-FDMA transmissions take place within gaps of L-FDMA transmissions.

7. The method of claim 6 wherein the step of repeating the block of symbols a number of times comprises the step of repeating the block a number of times equal to a CRF (Chip Repetition Factor).

8. The method of claim 6 wherein the user-dependent frequency shift vector is based on a value of F_{offs}.

9. An apparatus comprising:
a receiver receiving D-FDMA parameters; and
a transmitter transmitting using a D-FDMA transmission scheme, wherein D-FDMA transmissions take place within gaps of L-FDMA transmissions from other users.

10. The apparatus of claim 9 wherein the D-FDMA parameters comprise values for CRF, Q, and F_{offs}.

11. The apparatus of claim 9 wherein the transmitter further requests from a base station, the D-FDMA parameters.

12. The apparatus of claim 9 further comprising:
a Q-point FFT receiving a modulated symbol block and outputting a Q-point FFT of the modulated symbol block;
a mapper receiving the FFT of the modulated symbol block and outputting Q information streams; and
an N-point IFFT receiving the Q information streams and outputting an N-point IFFT of the Q information streams to the transmitter.
